(19) United States
(12) Patent Application Publication
(10) Pub. No.: US 2025/0225432 A1
(43) Pub. Date: Jul. 10, 2025

(54) APPARATUS AND METHOD FOR DATA STRUCTURE GENERATION

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto, ON (CA)

(21) Appl. No.: 18/408,195

(22) Filed: Jan. 9, 2024

(51) Int. Cl. G06N 20/00

(52) U.S. Cl. CPC G06N 20/00

(57) ABSTRACT

An apparatus for data structure generation using machine learning is provided. The apparatus may be configured to receive a user profile from a user, wherein the user profile comprises activity metrics and an endpoint element. In various embodiments, the apparatus may be configured to identify an aptitude measurement as a function of the user profile. In various embodiments, the apparatus may be configured to determine a data structure as a function of the aptitude measurement, wherein the data structure comprises first parameter changes. In various embodiments, the apparatus may be configured to display the data structure using a display device.

### FIELD OF THE INVENTION

The present invention generally relates to the field of artificial intelligence. In particular, the present invention is directed to an apparatus and a method for the generation of a data structure.

### BACKGROUND

Uncertainties in monetary management can result in lost profits, a decrease in strategic confidence, and the like. There is a need for guidance in strategic approaches related to management of assets and skills.

### SUMMARY OF THE DISCLOSURE

In an aspect, an apparatus for data structure generation using machine learning is provided. The apparatus includes a processor and a memory communicatively connected to the processor. The memory contains instructions configuring the processor to receive a user profile from a user, wherein the user profile comprises activity metrics and an endpoint element, identify an aptitude measurement as a function of the user profile, determine a data structure as a function of the aptitude measurement, wherein the data structure comprises first parameter changes, and display the data structure using a display device.

In another aspect, a method for the generation of a data structure using machine learning is provided. The method includes receiving, by a processor, a user profile from a user, wherein the user profile comprises activity metrics and an endpoint element, identifying, by the processor, an aptitude measurement as a function of the user profile, determining, by the processor, a data structure as a function of the aptitude measurement, wherein the data structure comprises first parameter changes, and displaying, by the processor, the data structure using a display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for the generation of a data structure;

FIG. 2 is a block diagram of an exemplary machine-learning process;

FIG. 3 is a diagram of an exemplary embodiment of a neural network;

FIG. 4 is a diagram of an exemplary embodiment of a node of a neural network;

FIG. 5 is an illustration exemplary embodiment of fuzzy set comparison;

FIG. 6 is a flow diagram of an exemplary method for the generation of the data structure; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and a method for the generation of a data structure is disclosed. The apparatus includes at least a processor and a memory communicatively connected to the at least a processor. Often entrepreneurs conduct activities that may not contribute to monetary gain. Identifying an entrepreneur's capabilities and attributes as well as a climate of the current market can assist the entrepreneur in positive decision-making. Furthermore, data structure may provide and/or facilitate total cash confidence of for an entrepreneur by providing information relating to a profitability factor. For instance, and without limitation, data structure may provide information to maintaining current and future profits. Data structure may also provide predictions related to expected future earnings. Thus, a strategic schedule may include steps and processes that guide the entrepreneur in beneficial monetary management.

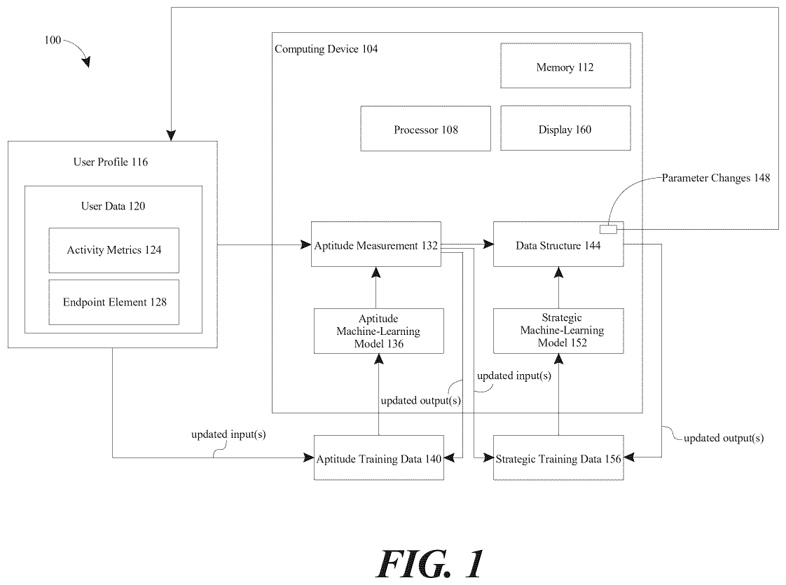

Referring now to FIG. 1, an exemplary embodiment of an apparatus 100 for generation of a data structure data is illustrated. In one or more embodiments, apparatus 100 may include a computing device 104. In one or more embodiments, apparatus 100 includes a processor 108. Processor 108 may include, be included in, or communicate with any computing device as described in this disclosure, including without limitation a microcontroller, microprocessor, digital signal processor (DSP), and/or system on a chip (SoC) as described in this disclosure. Computing device 104 may include, be included in, and/or communicate with a mobile device such as a mobile telephone or smartphone. Processor 108 may include a single computing device operating independently, or may include two or more computing device operating in concert, in parallel, sequentially or the like; two or more computing devices may be included together in a single computing device or in two or more computing devices. Processor 108 may interface or communicate with one or more additional devices as described below in further detail via a network interface device. Network interface device may be utilized for connecting processor 108 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 108 may include but is not limited to, for example, a computing device or cluster of computing devices in a first location and a second computing device or cluster of computing devices in a second location. Processor 108 may include one or more computing devices dedicated to data storage, security, distribution of traffic for load balancing, and the like. Processor 108 may distribute one or more computing tasks as described below across a plurality of computing devices of computing device, which may operate in parallel, in series, redundantly, or in any other manner used for distribution of tasks or memory between computing devices. Processor 108 may be implemented using a “shared nothing” architecture in which data is cached at the worker, in an embodiment, this may enable scalability of system 100 and/or computing device.

With continued reference to FIG. 1, processor 108 may be designed and/or configured to perform any method, method step, or sequence of method steps in any embodiment described in this disclosure, in any order and with any degree of repetition. For instance, processor 108 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 108 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 include a memory 112. Memory 112 is communicatively connected to processor 108. Memory 112 may contain instructions configuring processor 108 to perform tasks as disclosed in this disclosure. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 108 may be configured to receive a user profile 116 of a user. For the purposes of this disclosure, a “user profile” is a representation of information and/or data describing characteristics or attributes associated with a user. A user profile 116 may include a plurality of user data 120. As used in this disclosure, “user data” is information regarding current characteristics or attributes of the user. In one or more embodiments, user profile 116 may include an organized structure or visual representation of user data 120. User profile 116 may be created by processor 108, a user, or a third party as a function of user data. User data 120, and thus user profile 116, may include any of the following attributes of the user: age, weight, height, gender, credit, geographical location, financial information, medical history, marital status, relationship history, familial history, user goals, business goals, productivity goals, mindsets, temperaments, and the like. For example, and without limitation, user data 120 may include information about the user's occupation. In one or more embodiments, user data 120 may include information related to knowledge of the user, an attitude of the user, skills of the user, habits of the user, and the like. Goals or expectations of the user may be consistent with expectations or preferences described in U.S. patent application Ser. No. 18/398,446, filed on Dec. 28, 2023, titled “APPARATUS AND METHOD FOR DETERMINING ACTION GUIDES,” and, U.S. patent application Ser. No. 18/398,339, filed on Dec. 28, 2023, titled “APPARATUS AND METHODS FOR DETERMINING A RESOURCE DISTRIBUTION,” both of which are incorporated herein by reference herein in their respective entireties.

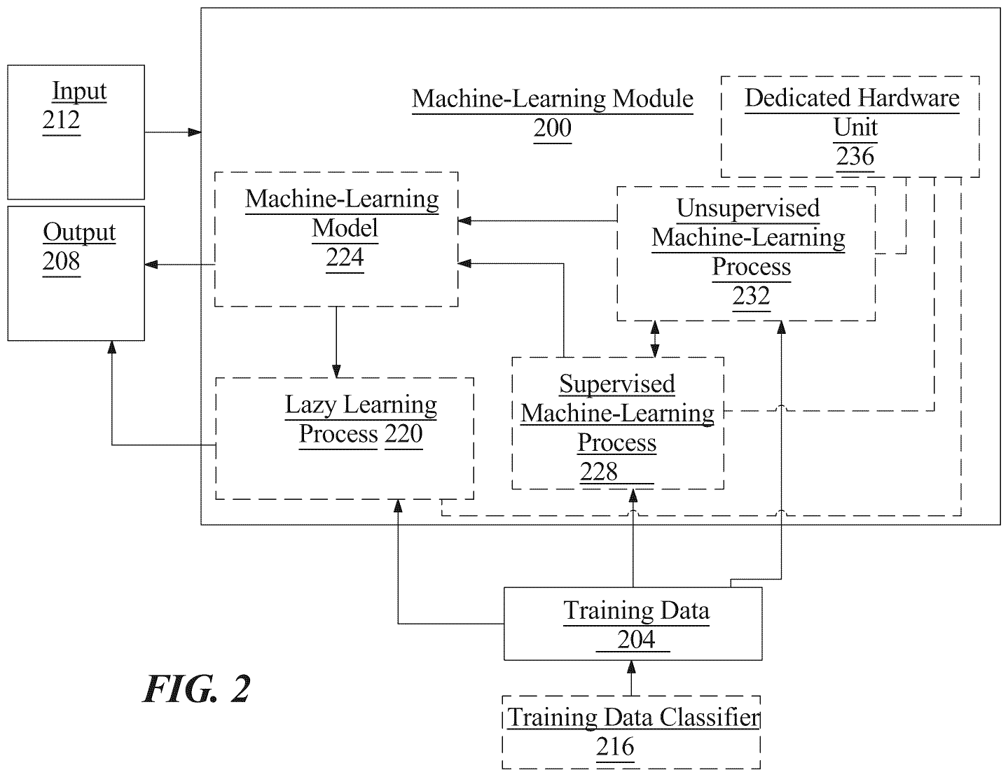

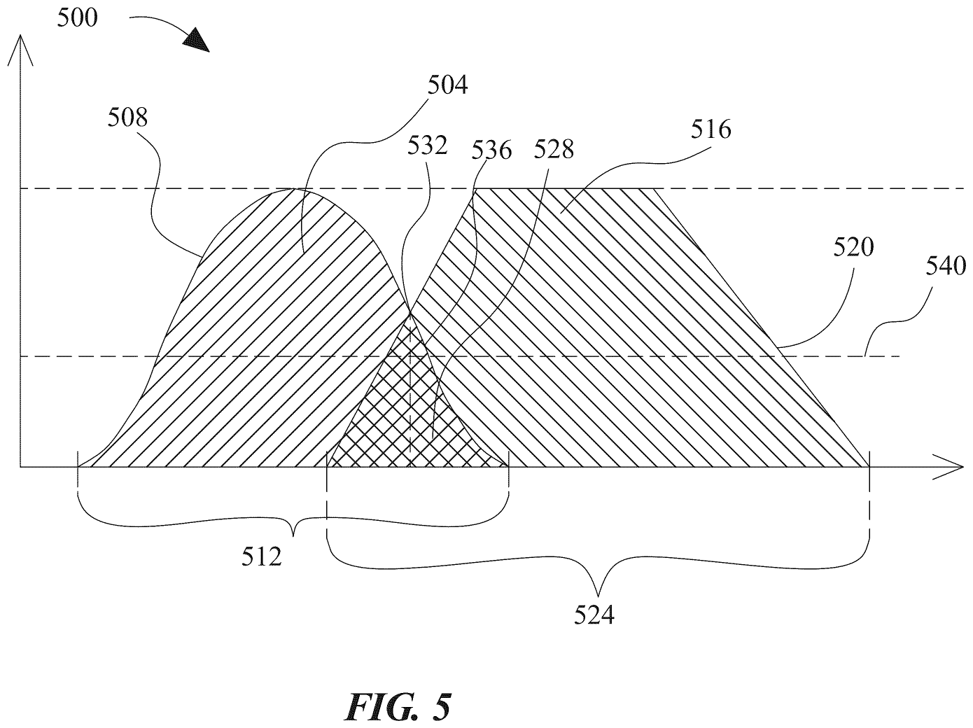

With continued reference to FIG. 1, user data 120 may include one or more activity metrics 124 and/or endpoint elements 128. As used in the current disclosure, “activity metrics” are data related to actions of the user. In one or more embodiments, activity metrics 124 may include one or more tasks that the user has done, is in progress of doing, or plans to complete. In one or more embodiments, tasks may be executed to achieve, for example, an endpoint element 128, as discussed further below. In some embodiments, activity metrics 124 may include a description of all of the tasks and sub-tasks that a user accomplishes in a given time period. This may include personal and professional tasks. Activity metrics 124 may describe the responsibilities of a user or associated third parties, such as an employee, manager, or owner. Activity metrics 124 may represent internal or external tasks as it relates to an entity of the user (e.g., company, business, employer, or the like). Examples of activity metrics 124 may include but are not limited to data describing managerial responsibilities, personal goals, business, goals, financial goals, financial decisions, spending, earnings, providing a service, making goods, maintaining a facility, interfacing with clients, accounting activities, product selection, ordering inventory, hiring/firing of employees, employee management, resource management, assigning tasks, and the like. In one or more embodiments, activity metrics 124 may include current financial metrics, such as gross profit margins, net profit margin, return on investment (ROI), cash conversion cycle (CCC), debt-to-equity, and the like. In one or more embodiments, activity metrics 124 may be entered into processor 108 by a user or a third party. Processor 108 may additionally be configured to generate activity metrics 124 based on the purpose of the entity, job descriptions of the user, asset inventory, the number of goods promised, the number of services to be provided, a desired income of the user, desired spending of the user, and the like. This may be done using a machine-learning model, such as the machine-learning model described in FIG. 2, or fuzzy inference set, such as the fuzzy set inference of FIG. 5.

With continued reference to FIG. 1, in one or more embodiments, activity metrics 124 may include interactions between user and specified products and/or services. For instance, and without limitation, activity metrics 124 may include physical interactions, such as, for example, foot traffic at a store owned by the user. In one or more embodiments, activity metrics 124 may include levels of interest for a service and/or product of the user. For example, and without limitation, levels of interest may include number of “likes” on a social media posting related to a product and/or service of the user. In another example, and without limitation, levels of interest may be a number of likes compared to total viewership of a posting related to a product or service of the user. In one or more embodiments, activity metrics 124 may include a quantitative measurement calculated based on levels of interaction between customers and products and/or services of a user. In one or more embodiments, activity metrics 124 may include foot traffic related to an event of the user. In one or more embodiments, activity metrics 124 may include ratings by users of products and/or services.

With continued reference to FIG. 1, user data 120 may include endpoint elements 128, as previously mentioned above in this disclosure. For the purposes of this disclosure, an “endpoint element” is a current goal or desired achievement of the user. For instance, and without limitation, an endpoint metric 128 may include a financial or monetary goal, such as desired annual income, monetary management, business revenue, achieved savings, and the like. In another instance, and without limitation, endpoint metric 128 may include a goal of an entity of the user or a career goal of the user. For example, endpoint metric 128 may include a future job title, acquired skill set, entity revenue, entity size, asset inventory, and the like. In one or more embodiments, activity metrics 124 may include financial metrics of an entity of the user. In one or more embodiments, endpoint data 128 may include desired financial metrics, such as gross profit margins, net profit margin, return on investment (ROI), cash conversion cycle (CCC), debt-to-equity, and the like. In one or more embodiments, endpoint element 128 may include a duration of time which the user desires to achieve the specific goal. For example, and without limitation, the user may wish to achieve a gross income of $200,000 per year within the next 3 years.

With continued reference to FIG. 1, in one or more embodiments, user profile 116 may be received by processor 108 through user input. For example, and without limitation, the user or a third party may manually input user profile 116 using a graphical user interface of processor 108 or a remote device communicatively connected to processor 108, such as for example, a smartphone or laptop. The user profile 116 may additionally be generated via the answer to a series of questions. In one or more embodiments, a series of questions may be implemented using a chatbot. Chatbot may be configured to generate questions regarding any elements or parameters of user profile 116. In a non-limiting embodiment, a user may be prompted to input specific information or may fill out a questionnaire. In some embodiments, a graphical user interface may display a series of questions to prompt a user for information pertaining to user profile 116. User profile 116 may be transmitted to processor 108, such as through a wired or wireless communication, as previously discussed in this disclosure. User profile 116 can be retrieved from multiple sources third-party sources including the user's inventory records, financial records, human resource records, past user profiles, sales records, user notes and observations, and the like. In one or more embodiments, user profile 116 may be placed through an encryption process for security purposes. In one or more embodiments, and without limitation, user input may include a business balance sheet. In other instances, and without limitation, user input may include a questionnaire. In one or more embodiments, user input may be received through a graphical user interface (GUI). In one or more embodiments, user input may include any data related to actions of a user or their entity (e.g., business), as previously mentioned in this disclosure. In one or more embodiments, user input may be received through any source of financial data, such as accounting software, point of sale (POS) systems, customer relationship management software, and the like. In one or more embodiments, user input may be received from a database. In one or more embodiments, user input may include surveys related to a product or service.

With continued reference to FIG. 1, in one or more embodiments, user profile 116 may be generated using a smart assessment. As used in this disclosure, a “smart assessment” is a set of questions that asks for user's information as described in this disclosure. In some cases, questions within smart assessment may include selecting a selection from a plurality of selections as answers. In other cases, questions within smart assessment may include free user input as answers. In a non-limiting example, a smart assessment may include a question asking the user regarding project data; for instance, the question may be “What is the end goal of this project?” In some cases, a smart assessment may be in a form such as, without limitation, survey, transactional tracking, interview, report, events monitoring, and the like thereof. In some embodiments, a smart assessment may include a data submission of one or more documents from the user. A “data submission,” for the purpose of this disclosure, is an assemblage of data provided by the user as an input source. In a non-limiting example, data submission may include a user uploading one or more data collections to processor 108. Additionally, or alternatively, user profile 116 may include one or more answers to smart assessment.

With continued reference to FIG. 1, processor 108 may receive user records to create user profile 116. For the purposes of this disclosure, a “user record” is a document that contains personal information associated with the user. User records may include user credentials, reports, financial records, medical records, employment history, business records, skills, and government records (i.e. birth certificates, social security cards, and the like). A user record may additionally include an employee record. An employee record may include things like employee evaluations, human resource records, client files, invoices, timecards, driver's license databases, news articles, social media profiles and/or posts, and the like. User records may be identified using a web crawler. User records may include a variety of types of “notes” entered over time by the user, employees of the user, support staff, advisors, and the like. User records may be converted into machine-encoded text using an optical character reader (OCR).

Still referring to FIG. 1, in some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e. a binary image). Binarization may be performed as a simple way of separating text (or any other desired image component) from the background of the image component. In some cases, binarization may be required for example if an employed OCR algorithm only works on binary images. In some cases. A line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted features can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIG. 2. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIG. 2.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, user profile 116 may be generated by, for example, processor 108, using a web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, processor 108 may generate a web crawler to compile the user profile 116 and user data. The web crawler may be seeded and/or trained with a reputable website, such as the user's business website, to begin the search. A web crawler may be generated by processor 108. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract user records, inventory records, financial records, human resource records, past user profiles, sales records, user notes, and observations, based on criteria such as a time, location, and the like.

With continued reference to FIG. 1, processor 108 is configured to identify an aptitude measurement 132 of the user as a function of user profile 116. More specifically, processor 108 may identify aptitude measurement 132 as a function of user data 120, such as, for example, activity metrics 124 and endpoint element 128. For the purposes of this disclosure, an “aptitude measurement” is information or data regarding capabilities of the user to achieve the endpoint element. For example, and without limitation, aptitude measurement 132 may include a probability of the user achieving endpoint element based off of current user data 120. In another example, and without limitation, aptitude measurement 132 may include a score (relative to a standard scale) based on the number of total activities or tasks accomplished by the user. In another example, and without limitation, aptitude measurement 132 may include a score (relative to a standard scale) based on the attributes, such as skills, past experience, and resources, of the user. In a non-limiting exemplary embodiment, aptitude measurement 132 may include a qualitative or quantitative value that indicates whether and/or which activities of the user contributed to achievement of endpoint element 128. For instance, and without limitation, aptitude measurement may include a “low” score that indicates that attributes and/or actions of the user are not desirably contributing to the attainability or achievement of endpoint element 128 of the user (e.g., a specific goal of the user). In another instance, and without limitation, aptitude measurement may include a “medium” score that indicates that the attributes or actions of the user are at least partially contributing to the user's attainability or achievement of endpoint element 128. In another instance, and without limitation, aptitude measurement 132 may include a “high” score that indicates that the attributes and/or actions of the user are desirably contributing to attainability or achievement of endpoint element 128.

With continued reference to FIG. 1, in one or more embodiments, aptitude measurement 132 may include information related to the user's current capabilities and progression for achieving endpoint element 128. For example, and without limitation, aptitude measurement 132 may include a quantitative or qualitative representation of user's productivity, benefit of specific attributes or skills, financial state progression (e.g., profitability), potential achievements, task completion or progression, goal progression, and the like. For instance, and without limitation, aptitude measurement 132 may include a profitability factor. A “profitability factor,” for the purposes of this disclosure, is a value representing a financial gain of a user. Profitability factor may include, for instance and without limitation, a numerical value representing current financial gains of the user or entity. For example, and without limitation, profitability factor may include a current income of user, a current revenue of an entity, or any other increase in a financial quantity of user. Aptitude measurement may include information evaluating the current efficiency and output of a user regarding achieving a goal. In one or more embodiments, processor 108 may identify aptitude measurement by comparing activity metrics 124 to an aptitude standard. In one or more embodiments, an aptitude standard may include an “ideal,” such as ideal attributes or action of a user, that would be implemented to achieve endpoint element 128. Aptitude standard may be provided by a database or be based off of previous history or the user or third parties, for example, aptitude standard may include examples of user data from third parties who are similarly situated by experience, job title, task, goals, time frames, and the like. For example, and without limitation, activity metrics 124 may describe tasks that were conducted by the user and a corresponding completion time for the user to complete the task; then aptitude standard may include an estimated or expected completion time to complete the task. The aptitude standard and the activity metric may then be compared to determine aptitude measurement 132 of the user. The comparison may be based off of, for example and without limitation, a time of completion of the task, or a quality of completion of the task. Excessive unproductive time (e.g., the user's time of completion is significantly slower than the aptitude standard suggested time) may negatively affect aptitude measurement 132. For example, and without limitation, the score of the aptitude measurement may be low if the difference between the actual time and the expected time is too high (e.g., higher than a predetermined threshold). In other exemplary embodiments, aptitude standard and user data, such as an attribute of the user may be compared to identify aptitude measurement. For example, and without limitation, an attribute of the user, such as an education level, may be compared to aptitude standard, such as an expected education level of a similarly situated individual.

With continued reference to FIG. 1, aptitude measurement 132 may be expressed as a numerical score or a linguistic value, as previously mentioned in this disclosure. Aptitude measurement 132 may be represented as a score used to reflect a current capability of the user. A non-limiting example, of a numerical scale, may include a scale from 1-10, 1-100, 1-1000. For example, and without limitation, a scale may include a 1-10 scale, where score of 1 may represent a user who is unproductive or far from achieving the endpoint element, whereas a rating of 10 may represent a user who is highly productive or close to achieving the endpoint element. Examples of linguistic values may include, “Below Average Aptitude,” “Average Aptitude,” “Good Aptitude,” “Excellent Aptitude,” and the like. In some embodiments, a numerical score range may be represented by a linguistic value. As used in the current disclosure, a “numerical score range” is a range of scores that are associated with a linguistic value. For example, this may include a score of 0-2 representing “Below Average Aptitude” or a score of 8-10 representing “Excellent Aptitude.” In an embodiment, the aptitude measurement 132 may be displayed in a graphical manner. For example, and without limitation, aptitude measurement 132 may be shown or represented as a line graph, bar graph, pie chart, scatter plot, histogram, box and whisker plot, heat map, network graph, and the like.

With continued reference to FIG. 1, standard aptitude may include a numerical score range representing an ideal aptitude of the user. Processor 108 may adjust the numerical score range of aptitude standard according to a desired level of production, time duration, or endpoint element of the user. Alternatively, processor 108 may adjust the numerical score range to indicate the impact one or more attributes of the user may have on the capability of the user to achieve endpoint element 128. A numerical score range may be determined by comparing the desired level of aptitude from the user to previous iterations of the numerical score ranges. Previous iterations' numerical score ranges may be taken from users who are similarly situated to the current user by experience, job title, task, and overall productivity, and the like. Previous iterations of a numerical score range may be received from, for example, a database. A numerical score range may be generated using a range machine-learning model. As used in the current disclosure, a “range machine-learning model” is a machine-learning model that is configured to identify a numerical score range. The range machine-learning model may be consistent with the machine-learning model described below in FIG. 2. For example, and without limitation, inputs to the range machine-learning model may include a past user profile, past activity metrics, past user data, past aptitude measurements, and the like. Outputs to range machine-learning model may include a numerical score range.

With continued reference to FIG. 1, processor 108 may identify aptitude measurement 132 using an aptitude machine-learning model 136. As used in the current disclosure, an “aptitude machine-learning model” is a machine-learning model that is configured to identify one or more aptitude measurements 132. Aptitude machine-learning model may be consistent with the machine-learning model described below in FIG. 2. Inputs to aptitude machine-learning model 136 may include user profile 116, such as user data 120, activity metrics 124, and endpoint element 128, and the like. Outputs to aptitude machine-learning model 136 may include aptitude measurement 132. Aptitude training data is a plurality of data entries containing a plurality of inputs that are correlated to a plurality of outputs for training a processor by a machine-learning process. In an embodiment, aptitude training data may comprise a plurality of exemplary user profiles 116 correlated to exemplary aptitude measurements 132. Aptitude training data may be received from, for example, database. Aptitude training data 140 may contain information regarding user profile 116, user data 120, activity metrics 124, endpoint element 128, and the like. Machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning models, learning vector quantization, and/or neural network-based machine-learning models. In one or more embodiments, aptitude machine-learning model 136 may include any machine-learning model described in this disclosure, such as machine-learning model 200 of FIG. 2. In one or more embodiments, aptitude machine-learning model 136 may receive an input, such as user profile 116, user data, activity measurements 112, user goal, and the like, to determine an output, such as aptitude measurement 132.

With continued reference to FIG. 1, processor 108 is configured to determine a data structure 144 as a function of aptitude measurement 132. As used in the current disclosure, a “data structure” is a representation of information or data feedback related to achieving the endpoint element. Data structure 144 may include instructions describing steps or processes the user may take to achieve endpoint. Data structure 144 may include information regarding how a user spent his/her time, these may be separated by task or time increments. Engagement of the user may refer to the amount of time a user spends on a task and the percentage of that time a user is actively engaged in completing that task. For example, and without limitation, if a user is tasked with completing a report as described by activity metrics 124. Data structure 144 may describe how long it takes a user to draft a report and how that time was spent. This may include a portion of time delegated to research, drafting, revision, and the like. Data structure 144 may include information regarding current desirable attributes of user or recommend attributes of the user to increase the user's aptitude measurement.

With continued reference to FIG. 1, processor 108 may be configured to determine data structure 144 as a function of aptitude measurement 132. As previously mentioned, data structure” is a representation of information or data regarding recommended parameter changes to change the aptitude measurement of the user. In one or more embodiments, data structure 144 may include parameter changes 148. For the purposes of this disclosure, “parameter changes” are instructions or data including recommendations or adjustments to a user profile. For instance, parameter changes may include instructions to a user that the user may implement to increase the user's capability, and thus chances, of achieving endpoint element (e.g., a goal). In one or more embodiments, parameter changes 148 may include one or more instructions to adjust favorably or positively (e.g., increase) the score of the aptitude measurement. Thus, parameter changes 148 may include feedback functions that provide parameter alterations (e.g., instructions) that a user may follow to create a more desirable aptitude measurement and, therefore, achieve or more quickly achieve endpoint element. In other embodiments, parameter changes 148 may include feedback regarding maintaining current earnings or profits. For instance, and without limitation, parameter changes 148 may include feedback functions for maintaining current profits, income, revenue, and the like, related to profitability factor. For instance, and without limitation, parameter changes 148 may include recommendations or suggestions related to increasing advertisements to increase a customer base, acquiring education in a particular field to increase a skill set, proposed investments, proposed allocation of resources, and the like, to maintain profits of profitability factor of user.

With continued reference to FIG. 1, processor 108 may generate data structure 144 using a strategic machine-learning model 152. As used in the current disclosure, a “strategic machine-learning model” is a machine-learning model that is configured to generate data structure 144. In some embodiments, strategic machine-learning model may include a strategic classifier, which may be consistent with the classifier described below in FIG. 2. Inputs to the strategic machine-learning model 152 may include user profile 116 (e.g., activity metrics 124 or endpoint element 138) and/or aptitude measurement 132. Outputs to strategic machine-learning model 152 may include data structure 144 and corresponding parameter changes 148, which includes information associated with improving actions or attributes of the user to assist the user in achieving the particular goal or achieve the particular goal within a predetermined duration of time. In an embodiment, strategic machine-learning model 152 may classify a plurality of aptitude measurements 132 correlated into two or more categories. In non-limiting embodiments, those categories may include positive and negative aptitude measurements. For example, and without limitation, aptitude measurement 132 may include a plurality of aptitude measurements, where each of the aptitude measurements of the plurality of aptitude measurements is categorized into positive aptitude measurements (e.g., “high” or “desirable” scores) and negative aptitude measurements (e.g., “low” or “undesirable” scores). Processor 108 may be configured to determine if an aptitude measurement is positive or negative by, for example, comparing the score of aptitude measurement to a predetermined threshold. For the purposes of this disclosure, a “predetermined threshold” is a value or range that defines a limitation. For instance, and without limitation, predetermined threshold may include an upper threshold and/or a lower threshold, where the upper threshold includes an upper limit (e.g., an aptitude measurement with a score above the lower threshold may be considered a positive aptitude measurement) and the lower threshold includes a lower limit (e.g., an aptitude measurement with a score below the lower threshold may be considered a negative aptitude measurement). In one or more embodiments, strategic training data 156 is a plurality of data entries containing a plurality of inputs that are correlated to a plurality of outputs for training a processor by a machine-learning process. In an embodiment, strategic training data 156 may comprise a plurality of aptitude measurements 120 correlated to examples of data structures 144. Strategic training data may be received from, for example, a database. Strategic training data may contain information regarding user profile 116, activity metrics 124, aptitude measurement 132, an example of data structure 144, and the like. Classifier may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, a classifier, such as strategic machine-learning model 152, may be implemented as a fuzzy inferencing system. As used in the current disclosure, a “fuzzy inference” is a method that interprets the values in the input vector (i.e., aptitude measurements 132 and examples of data structures 144) and, based on a set of rules, assigns values to the output vector. A set of fuzzy rules may include a collection of linguistic variables that describe how the system should make a decision regarding classifying an input or controlling an output. An example of linguistic variables may include variables that represent one or more data structures 144. Examples of linguistic variables may include terms such as “Low,” “Moderate,” and “High.” Aptitude measurements 132 and examples of data structure 144 may each individually represent a fuzzy set. Data structure 144 may be determined by a comparison of the degree of match between a first fuzzy set and a second fuzzy set, and/or single values therein with each other or with either set, which is sufficient for purposes of the matching process.

Still referring to FIG. 1, data structure 144 may be determined as a function of the intersection between two fuzzy sets. Ranking the data structure 144 may include utilizing a fuzzy set inference system as described herein below, or any scoring methods as described throughout this disclosure. For example, without limitation processor 108 may use a fuzzy logic model to determine data structure 144 as a function of fuzzy set comparison techniques as described in this disclosure. In some embodiments, each piece of information associated with a plurality of aptitude measurements 132 may be compared to one or more examples of data structure 144, wherein data structure 144 may be represented using a linguistic variable on a range of potential numerical values, where values for the linguistic variable may be represented as fuzzy sets on that range; a “good” or “ideal” fuzzy set may correspond to a range of values that can be characterized as ideal, while other fuzzy sets may correspond to ranges that can be characterized as mediocre, bad, or other less-than-ideal ranges and/or values. In embodiments, these variables may be used to compare aptitude measurements 132 and examples of data structures 144 with a goal of generating data structure 144 specific to the user profile 116. A fuzzy inferencing system may combine such linguistic variable values according to one or more fuzzy inferencing rules, including any type of fuzzy inferencing system and/or rules as described in this disclosure, to determine a degree of membership in one or more output linguistic variables having values representing ideal overall performance, mediocre or middling overall performance, and/or low or poor overall performance; such mappings may, in turn, be “defuzzified” as described in further detail below to provide an overall output and/or assessment.

Still referring to FIG. 1, the processor may be configured to generate a machine-learning model, such as strategic machine-learning model 152, using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A) P (A)=P (B), where P (A/B) is the probability of hypothesis A given data B also known as posterior probability; P (B/A) is the probability of data B given that the hypothesis A was true; P (A) is the probability of hypothesis A being true regardless of data also known as prior probability of A; and P (B) is the probability of the data regardless of the hypothesis. A naïve Bayes algorithm may be generated by first transforming training data into a frequency table. Processor 108 may then calculate a likelihood table by calculating probabilities of different data entries and classification labels. processor 108 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor 108 may be configured to generate a machine-learning model, such as strategic machine-learning model 152, using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm l=\sqrt{Σᵢ₌₀ⁿaᵢ²}, where aᵢ is attribute number experience of the vector. Scaling and/or normalization may function to make vector comparison independent of absolute quantities of attributes, while preserving any dependency on the similarity of attributes; this may, for instance, be advantageous where cases represented in training data are represented by different quantities of samples, which may result in proportionally equivalent vectors with divergent values.

Still referring to FIG. 1, processor 108 may be configured to display data structure 144 using a display device 160. As used in the current disclosure, a “display device” is a device that is used to display content. Display device 160 may include a user interface. A “user interface,” as used herein, is a means by which a user and a computer system interact; for example through the use of input devices and software. User interface may include a graphical user interface (GUI), command line interface (CLI), menu-driven user interface, touch user interface, voice user interface (VUI), form-based user interface, any combination thereof, and the like. User interface may include a smartphone, smart tablet, desktop, or laptop operated by the user. In an embodiment, the user interface may include a graphical user interface. A “graphical user interface (GUI),” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. Menu bar may be displayed horizontally across the screen such as pull down menu. When any option is clicked in this menu, then the pull down menu may appear. Menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like. Data structures may be consistent with data structures described in U.S. patent application Ser. No. 18/406,756, filed on Jan. 8, 2024, titled “APPARATUS AND METHODS FOR DETERMINING A RESOURCE GROWTH PATTERN,” and, U.S. patent application Ser. No. 18/398,366, filed on Dec. 28, 2023, titled “APPARATUS AND METHODS FOR MODEL SELECTION BETWEEN A FIRST MODEL AND A SECOND MODEL USING PROJECTOR INFERENCING,” both of which are incorporated herein by reference herein in their respective entireties.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, range machine-learning model may include past user profile, past activity metrics, past user data, and/or past aptitude measurement inputs and numerical score range outputs, as previously described in FIG. 1. As another non-limiting illustrative example, aptitude machine-learning model may include user profile, such as user data, activity metrics, and/or endpoint element inputs and aptitude measurement outputs.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to sub-categories such as user profile sub-categories, user data sub-categories, activity sub-categories, and the like for inputs of range machine-learning model or aptitude machine-learning model. Similarly, outputs of machine-learning models may be classified into sub-categories, such as, for example, outputs sub-categories for range machine-learning model may include low, medium, high, and sub-categories for aptitude machine-learning model may include areas of aptitude.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include a past or current user profile, activity metrics, user data, aptitude measurements as described above as inputs, numerical score range as outputs for range-machine-learning model or aptitude measurements as outputs for aptitude machine-learning model, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAS, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

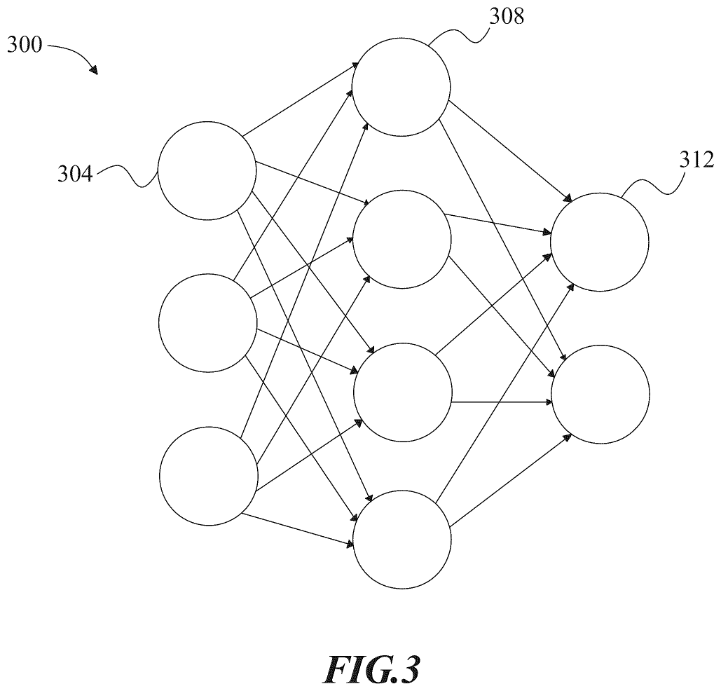

Referring now to FIG. 3, an exemplary embodiment of neural network 300 is illustrated. A neural network 300, also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

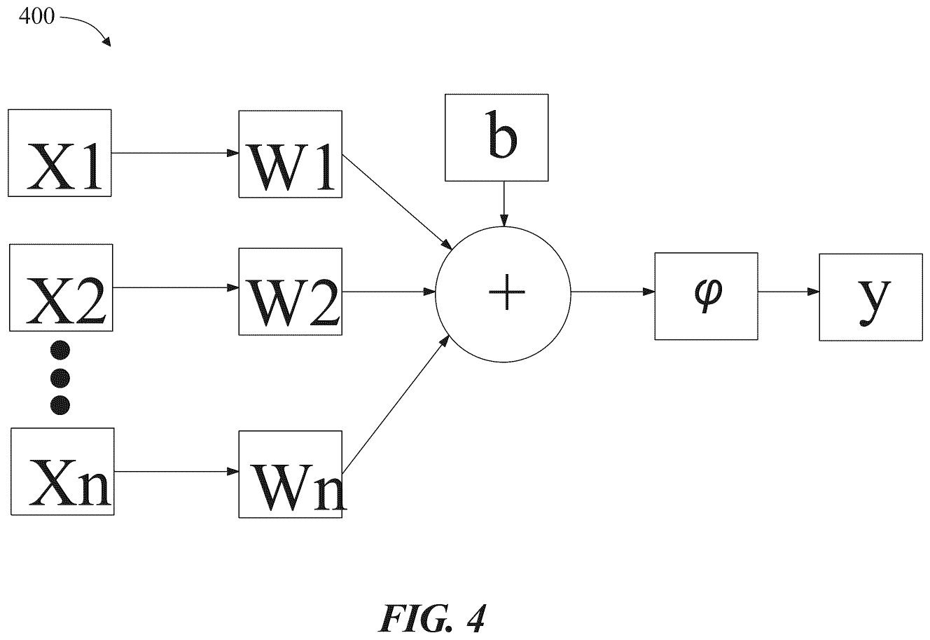

Referring now to FIG. 4, an exemplary embodiment of a node of a neural network 400 is illustrated. A node may include, without limitation, a plurality of inputs x, that may receive numerical values from inputs to a neural network containing the node and/or from other nodes. Node may perform a weighted sum of inputs using weights w′, that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights w′, may be determined by training a neural network using training data, which may be performed using any suitable process as described above.

Now referring to FIG. 5, an exemplary embodiment of fuzzy set comparison 500 is illustrated. In a non-limiting embodiment, the fuzzy set comparison. In a non-limiting embodiment, fuzzy set comparison 500 may be consistent with fuzzy set comparison in FIG. 1. In another non-limiting the fuzzy set comparison 500 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent a plurality of aptitude measurements 132 and an example of data structure 144 from FIG. 1.

Alternatively or additionally, and still referring to FIG. 5, fuzzy set comparison 500 may be generated as a function of determining data compatibility threshold. The compatibility threshold may be determined by a computing device. In some embodiments, a computing device may use a logic comparison program, such as, but not limited to, a fuzzy logic model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 5, inference engine may be implemented according to input a plurality of aptitude measurements 132 and an example of data structure 144. For instance, an acceptance variable may represent a first measurable value pertaining to the classification of a plurality of aptitude measurements 132 to an example of data structure 144. Continuing the example, an output variable may represent data structure 144 tailored to the user profile 116. In an embodiment, a plurality of aptitude measurements 132 and/or an example of data structure 144 may be represented by their own fuzzy set. In other embodiments, an evaluation factor may be represented as a function of the intersection of two fuzzy sets as shown in FIG. 5. An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 608 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 504 may represent any value or combination of values as described above, including any a plurality of aptitude measurements 132 and an example of data structure 144. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 536 that overlaps, first membership function 508 and second membership function 520 may intersect at a point 532 representing a probability, as defined on probability interval, of a match between first fuzzy set 504 and second fuzzy set 516. Alternatively or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, an data structure 144 may indicate a sufficient degree of overlap with fuzzy set representing a plurality of aptitude measurements 132 and an example of data structure 144 for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both a plurality of aptitude measurements 120 and an example of a data structure 144 have fuzzy sets, a data structure 144 may be generated by having a degree of overlap exceeding a predictive threshold, processor 108 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

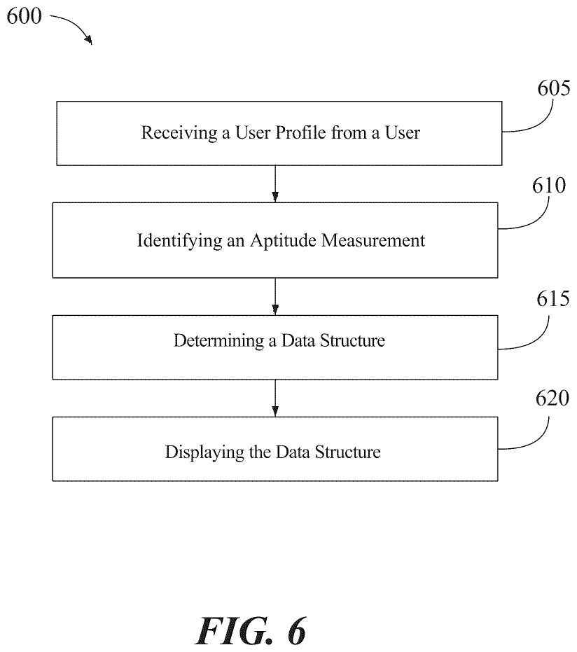

Referring now to FIG. 6, a flow diagram of an exemplary method 600 for the generation of data structure 144 using machine learning is illustrated. At step 605, method 600 includes receiving, by processor 108, user profile 116 from the user. In one or more embodiments, the user profile 116 may include activity metrics 124 and endpoint element 128. This may be implemented as described and with reference to FIGS. 1-5. In one or more embodiments, the endpoint element includes a goal of the user. In one or more embodiments, the activity metric comprises a task of the user.

Still referring to FIG. 6, at step 910, method 900 includes identifying, by processor 108, aptitude measurement 132 as a function of user profile 116. This may be implemented as described and with reference to FIGS. 1-5. In one or more embodiments, method 900 further includes the aptitude measurement including a plurality of aptitude measurements, and each of the aptitude measurements of the plurality of aptitude measurements may be categorized into positive aptitude measurements and negative aptitude measurements. This may be implemented as described and with reference to FIGS. 1-5. In one or more embodiments, the aptitude measurement is reflected as a numerical score. In one or more embodiments, the aptitude measurement includes a productivity score of the user. This may be implemented as described and with reference to FIGS. 1-5. In one or more embodiments, parameter changes may include one or more instructions to positively increase the score of the aptitude measurement. This may be implemented as described and with reference to FIGS. 1-5.

Still referring to FIG. 6, at step 915, method 900 includes determining, by processor 108, data structure 144 as a function of aptitude measurement 132. In one or more embodiments, data structure 144 may include first parameter changes 148. This may be implemented as described and with reference to FIGS. 1-5.

Still referring to FIG. 6, at step 920, method 900 includes displaying, by processor 108, data structure 144 using display device 160. This may be implemented as described and with reference to FIGS. 1-5. In one or more embodiments, method 900 further comprises receiving an updated user profile as a function of the parameter changes, identifying an updated aptitude measurement as a function of the updated user profile, and determining an updated data structure as a function of the updated aptitude parameter, where the updated data structure comprises first parameters changes and second parameter changes. This may be implemented as described and with reference to FIGS. 1-5. In one or more embodiments, determining the data structure may include determining the data structure using a machine-learning model. For instance, and without limitation, determining the data structure using the machine-learning model may include training the machine-learning model using training data, wherein the training data comprises a plurality of data entries containing exemplary user profiles as inputs correlated to exemplary data structures as outputs, and determining the data structure as a function of the aptitude measurement using the machine-learning model. This may be implemented as described and with reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

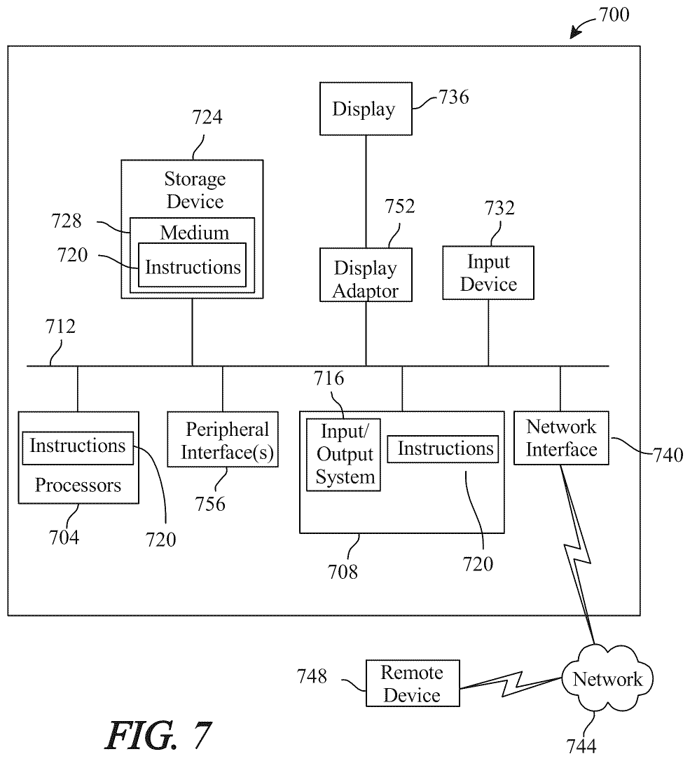

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for data structure generation using machine learning, wherein the apparatus comprises:
a processor; and
a memory communicatively connected to the processor, wherein the memory contains instructions configuring the processor to:
receive a user profile from a user, wherein the user profile comprises activity metrics and an endpoint element;
train an aptitude machine-learning model using aptitude training data wherein the aptitude training data comprises at least a user profile input correlated to an aptitude measurement;
identify the aptitude measurement as a function of a trained aptitude machine-learning model, wherein the aptitude measurement comprises a comparison of an education level of the user to an expected education level;
determine a data structure as a function of the aptitude measurement identified using the trained aptitude machine-learning model, wherein the data structure comprises first parameter changes, wherein the first parameter change comprises a feedback function wherein the feedback function configures alterations to the first parameter change as a function of user's desired aptitude measurement, wherein determining the data structure comprises:
receiving training data;
training a machine-learning model using the training data, wherein training the machine-learning model comprises
applying the training data to an input layer of nodes comprising a plurality of aptitude measurements identified using the trained aptitude machine-learning model, one or more intermediate layers of nodes, and an output layer of nodes comprising a plurality of data structures;
adjusting one or more connections and one or more weights between nodes in adjacent layers of the machine-learning model;
detecting additional correlations between the output layer of nodes and the input layer of nodes;
iteratively training the machine-learning model as a function of the detected additional correlations;
triggering retraining of the machine-learning model as a function of generation of one or more new training examples wherein the one or more new training examples exceed a preconfigured threshold;
sanitizing the training data using a dedicated hardware unit comprising circuitry configured to perform signal processing operations, wherein sanitizing the training data comprises:
determining by the dedicated hardware unit that a training data entry has a signal to noise ratio below a threshold value; and
removing the training data entry from the training data;
retraining the machine-learning model using the sanitized training data;
updating the retrained machine learning model as a function of an altered first parameter change; and
generating the data structure as a function of the aptitude measurement using the retrained machine-learning model; and
display the determined data structure and the first parameter change using a display device.

2. The apparatus of claim 1, wherein the memory contains instructions further configuring the processor to:
receive an updated user profile as a function of the parameter changes;
identify an updated aptitude measurement as a function of the updated user profile; and
determine an updated data structure as a function of the updated aptitude parameter, where the updated data structure comprises first parameters changes and second parameter changes.

3. The apparatus of claim 1, wherein:
the aptitude measurement comprises a plurality of aptitude measurements; and
each of the aptitude measurements of the plurality of aptitude measurements is categorized into positive aptitude measurements and negative aptitude measurements.

4. (canceled)

5. (canceled)

6. The apparatus of claim 1, wherein the aptitude measurement is reflected as a numerical score.

7. The apparatus of claim 1, wherein the endpoint element comprises a goal of the user.

8. The apparatus of claim 1, wherein the aptitude measurement comprises a productivity score of the user.

9. The apparatus of claim 1, wherein the parameter changes comprise one or more instructions to positively increase a score of the aptitude measurement.

10. The apparatus of claim 1, wherein the activity metric comprises a task of the user.

11. A method for generation of a data structure using machine learning, wherein the method comprises:
receiving, by a processor, a user profile from a user, wherein the user profile comprises activity metrics and an endpoint element;
training, by the processor, an aptitude machine-learning model using aptitude training data wherein the aptitude training data comprises at least a user profile input correlated to an aptitude measurement;
identifying, by the processor, the aptitude measurement as a function of a trained aptitude machine-learning model, wherein the aptitude measurement comprises a comparison of an education level of the user to an expected education level;
determining, by the processor, a data structure as a function of the aptitude measurement identified using the trained aptitude machine-learning model, wherein the data structure comprises first parameter changes, wherein the first parameter change comprises a feedback function wherein the feedback function configures alterations to the first parameter change as a function of user's desired aptitude measurement, wherein determining the data structure comprises:
receiving training data;
training a machine-learning model using the training data, wherein training the machine-learning model comprises:
applying the training data to an input layer of nodes comprising a plurality of aptitude measurements identified using the trained aptitude machine-learning model, one or more intermediate layers of nodes, and an output layer of nodes comprising a plurality of data structures;
adjusting one or more connections and one or more weights between nodes in adjacent layers of the machine-learning model;
detecting additional correlations between the output layer of nodes and the input layer of nodes;
iteratively training the machine-learning model as a function of the detected additional correlations;
triggering retraining of the machine-learning model as a function of generation of one or more new training examples wherein the one or more new training examples exceed a preconfigured threshold;
sanitizing the training data using a dedicated hardware unit comprising circuitry configured to perform signal processing operations, wherein sanitizing the training data comprises:
determining by the dedicated hardware unit that a training data entry has a signal to noise ratio below a threshold value; and
removing the training data entry from the training data;
retraining the machine-learning model using the sanitized training data;
updating the retrained machine learning model as a function of an altered first parameter change; and
generating the data structure as a function of the aptitude measurement using the retrained machine-learning model; and
displaying, by the processor, the determined data structure and the first parameter change using a display device.

12. The method of claim 11, wherein the method further comprises:
receiving an updated user profile as a function of the parameter changes;
identifying an updated aptitude measurement as a function of the updated user profile; and
determining an updated data structure as a function of the updated aptitude parameter, where the updated data structure comprises first parameters changes and second parameter changes.

13. The method of claim 11, wherein:
the aptitude measurement comprises a plurality of aptitude measurements; and
each of the aptitude measurements of the plurality of aptitude measurements is categorized into positive aptitude measurements and negative aptitude measurements.

14. (canceled)

15. (canceled)

16. The method of claim 11, wherein the aptitude measurement is reflected as a numerical score.

17. The method of claim 11, wherein the endpoint element comprises a goal of the user.

18. The method of claim 11, wherein the aptitude measurement comprises a productivity score of the user.

19. The method of claim 11, wherein the parameter changes comprise one or more instructions to positively increase a score of the aptitude measurement.

20. The method of claim 11, wherein the activity metric comprises a task of the user.
